(19) United States
(12) Patent Application Publication
(10) Pub. No.: US 2026/0311042 A1
(43) Pub. Date: Oct. 8, 2026

(54) POST DEPLOYMENT DETECTION OF DEGRADATION IN MACHINE-LEARNED MODELS

(71) Applicant: OPTUM, INC., Minnetonka, MN (US)

(72) Inventor: Sheng Ren, Irvine, CA (US)

(21) Appl. No.: 19/172,919

(22) Filed: Apr. 8, 2025

(51) Int. Cl. G06N 20/00

(52) U.S. Cl. CPC G06N 20/00

(57) ABSTRACT

Techniques for detecting degraded performance of a machine-learned model are described. The techniques utilize a set of data collected after the machine-learned model was last trained and the prior training data to detect model performance by determining one or more metrics based at least in part on test outputs and one or more training outputs that are derived from the set of data and the prior training data. The techniques may aggregate a retraining dataset for the machine-learned model based on at least part of the set of data and at least a portion of the prior training data. The retraining dataset may account for determined concept shifts between the set of data and the prior training data.

### TECHNICAL FIELD

The present disclosure generally relates to machine-learned models, and more particularly, to techniques for detecting degradation of machine-learned models following deployment.

### BACKGROUND

In many fields, machine-learned (ML) models are used to process data to generate or predict future data points, classify features of the data, and/or perform other similar tasks. However, real-world data may be different than the data used to train these ML models and/or the real-world data may change over time, resulting in degraded model performance over time. The uncertain and evolving nature of the data can make it difficult to determine whether performance problems detected in an ML model's output are the result of a flaw in the ML model or a temporary bias in the data. Conventional techniques for monitoring ML model performance can produce false positive indications that a model is performing poorly and false negative indications that a model is performing well.

### BRIEF DESCRIPTION OF THE DRAWINGS

The figures described below depict embodiments for purposes of illustration only. One skilled in the art will readily recognize from the following discussion that alternative embodiments of the systems and methods illustrated herein may be employed without departing from the principles of the disclosure described herein. The detailed description is described with reference to the accompanying figures. In the figures, the same reference number appearing in different figures indicates a same or similar item.

FIG. 1A depicts an example computing environment in which various embodiments of the present disclosure can be implemented.

FIG. 1B depicts an example machine learned model process.

FIG. 2A depicts a schematic diagram of example testing data.

FIG. 2B depicts a schematic diagram of example training data.

FIG. 3 depicts a flow diagram of an example computer-implemented method for detecting degradation of a machine-learned model.

FIG. 4 depicts a flow diagram of an example computer-implemented method for matching testing data and training data.

FIG. 5 depicts a flow diagram of an example computer-implemented method for determining that a machine-learned model needs retraining or fine-tuning.

FIG. 6 depicts a flow diagram of an example computer-implemented method for determining that a concept shift is present in testing data.

FIG. 7 depicts a flow diagram of an example computer-implemented method for determining portions of training data associated with a concept shift.

FIG. 8 depicts a flow diagram of another example computer-implemented method for detecting degradation of a machine-learned model.

### DETAILED DESCRIPTION

The techniques described herein relate generally to monitoring performance of a machine-learned (ML) model over time after the ML model was trained and detecting when performance of the ML model is degraded sufficiently to trigger retraining and/or fine-tuning the ML model. Furthermore, the techniques described herein may monitor the ML model performance as part of an “always on” automated feature, where a check for degradation of the ML model is triggered whenever a set amount of labeled post training data is available. To that end, the techniques described herein assess performance of the ML model when operating on (new) data after training is complete (e.g., inference data the model processes after training is complete) relative to performance of the ML model during training when operating on training and/or test data used to train and/or validate the ML model. The techniques may additionally or alternatively comprise determining one or more metrics based at least in part on a set of outputs generated by the model during inference (i.e., the period after deployment where training is complete or at least not ongoing for the time-being). These metrics may be used to assess performance of the ML model. For example, the one or more metrics may include confidence intervals calculated using the outputs generated by the model from the new data and from the training data, and overlaps in the two confidence intervals may indicate the model has not degraded enough to trigger retraining. Furthermore, when the metrics indicate that the performance of the ML model has degraded, the ML model is retrained or fine-tuned using a retraining dataset that is compiled or aggregated based on at least part of the new data and at least a portion of the training data.

Training, retraining, and/or fine-tuning the parameter values of ML models is a resource-intensive and time-consuming process. In particular, the amount of processing and energy resources needed to execute training operations for ML models has increased commensurately with increases in the number of parameter values used by top-of-the-line ML models. Moreover, given the complicated black box nature of the ML model parameters values, there is not a standard, easily achievable way to detect degradation in model performance. This is further complicated by the time-evolving nature of the data that is processed with the ML model. For example, the type of data an ML model is configured to process is not typically static following the initial training because new data may come in the form of small or large batches that can be biased due to seasonality, time lag in label availability, and many other reasons. Bias in the data may cause the model to perform less well, but the ML model itself may still be valid, and executing a retraining run would be costly and inefficient. Furthermore, oversensitivity to shifts in model performance may cause overfitting, which may degrade the average performance of the model, as the model may perform very well for short durations. Oversensitivity to shifts in model performance may also result in unnecessary high energy and/or computation use to conduct all the retraining/fine-tuning. However, when there are conflicting or new patterns in new data that stem from a “concept shift” or similar occurrence, the ML model will no longer perform well due to these new and conflicting patterns because the associations of features and labels learned from the original training data are not fully valid anymore.

The techniques described herein solve these problems by detecting degradation of a trained ML model using both the new data and relevant portions of the original training data (e.g., portions of the training data where the ML model would be expected to generate outputs similar to outputs generated by the post-training data). In this way, excess variation (e.g., variation beyond a threshold as compared to outputs from the original training data) in the outputs generated by the new data can be reliably attributed to changes within the new data that the ML model is unable to properly process, and therefore indicate the need to retrain the ML model.

Additionally, in cases where there is a concept shift such that the new data contradicts concepts that were present in the original training data, simply retraining the model based on the new data may fail to provide good performance because the parameters present in the ML model and the original training data contain samples that represent conflicting concepts. To solve this problem, the techniques described herein can determine that such a concept shift is present in the new data and then correct portions (e.g., by removing or altering entries) of the original training data that include the prior concept (that was determined to be changed) in the new post-training data. In this way, the techniques described herein can reuse the still-valid portions of the original training data, which ensures a large robust retraining dataset for the ML model.

Of course, it should be appreciated that the advantages and technical improvements described above and elsewhere herein are not the only advantages and/or technical improvements that may be realized as a result of the techniques described herein. Other advantages and/or technical improvements to the functioning of a computer itself or other technologies or technical fields may be apparent to one of ordinary skill in the art. Moreover, the techniques described herein may be readily applied in any suitable field for any suitable purpose.

### EXAMPLE COMPUTING ENVIRONMENT

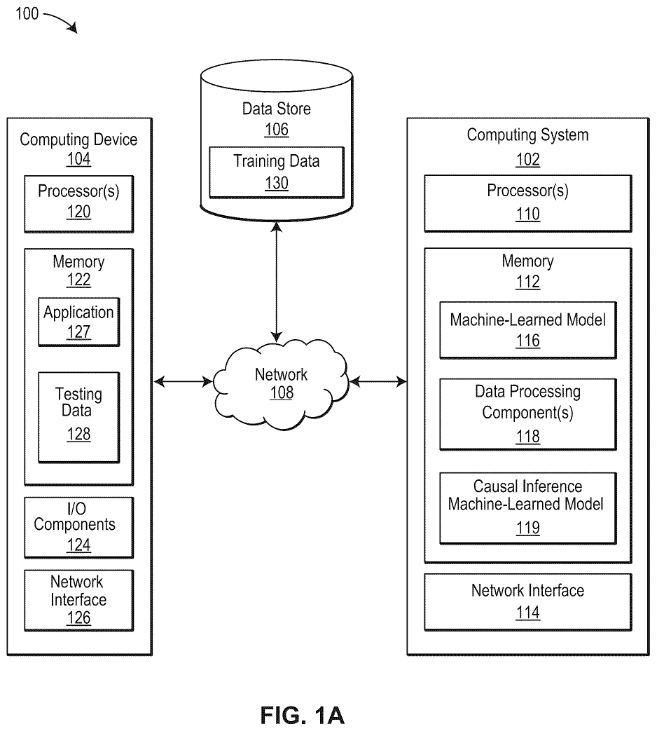

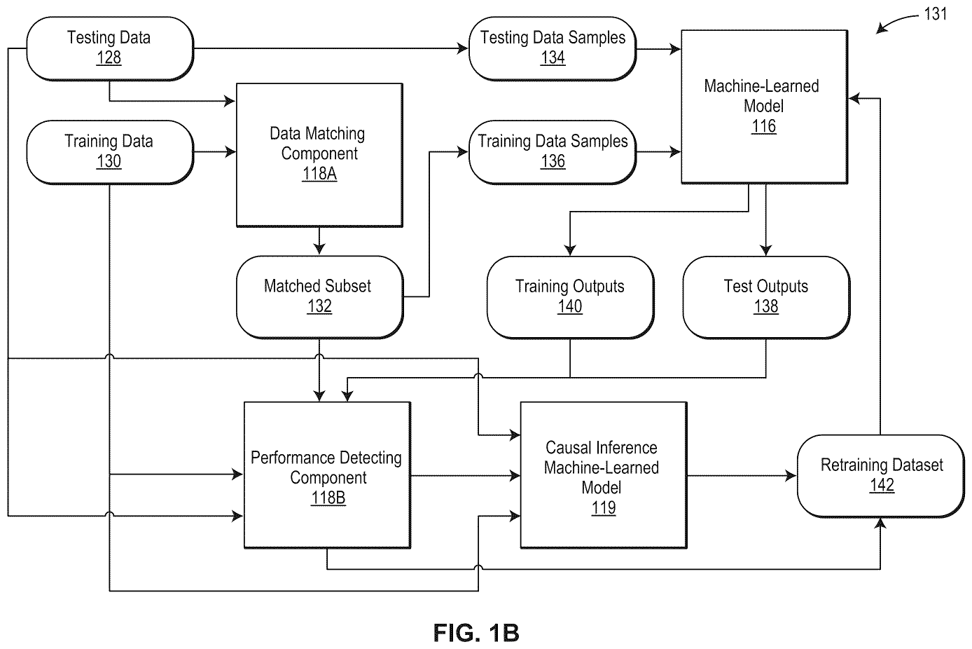

FIG. 1A depicts an example computing environment 100 in which various embodiments of the present disclosure may be implemented. Generally, the example computing environment 100 includes a computing system 102, a computing device 104, and a data store 106, some or all of which are communicatively coupled via a network 108.

Generally, the computing device 104 is associated with a user or other entity who may be seeking to detect degradation in an ML model managed by (or otherwise associated with) the computing system 102. The computing system 102 may include a single server, or multiple servers that are co-located and/or remotely distributed, for example. In some embodiments, the computing system 102 provides data visualization services via a cloud platform (e.g., Amazon Web Services (AWS)®, Microsoft Azure®, or Google Cloud®). The computing system 102 includes one or more processors 110, memory 112, and a network interface 114.

The processor(s) 110 may include any suitable number of processors and/or processor types. In some examples, the processor(s) 110 include one or more central processing units (CPUs), one or more graphics processing units (GPUs), one or more tensor processing units (TPUs), one or more field-programmable gate arrays (FPGAs), one or more application-specific integrated circuits (ASICs), and/or the like. Generally, the processor(s) 110 comprise hardware configured to execute instructions (e.g., processor-executable code/instructions) stored in the memory 112.

The memory 112 may include any suitable memory type(s), including one or more volatile memories (e.g., dynamic and/or static random-access memory (RAM)) and/or non-volatile memories (e.g., read-only memory (ROM), erasable programmable ROM (EPROM), electrically EROM (EEROM), NAND flash, and/or solid state drive(s) (SSD(s))), all or any of which are examples of non-transitory computer-readable media. In some examples, the memory 112 stores one or more of: an operating system; one or more software components (e.g., firmware, application(s), binary, source code, executable instructions, machine-learned model(s)); transient data and/or code loaded and/or operated on by one or more software component(s); and/or other suitable components/data). In the example computing environment 100, the memory 112 stores the processor-executable instructions of a machine-learned model 116, one or more data processing components 118 and a causal inference machine learned model 119.

In some embodiments, the memory 112 may store more, fewer, and/or different components, than what is depicted in FIG. 1A. In some embodiments, for example, some or all of the components that FIG. 1A shows as being stored in memory 112 are instead stored remotely, and are remotely accessed/used by the computing system 102. For example, the computing system 102 may remotely access the functionality of the machine-learned model 116 and the data processing components 118 (or just access the machine-learned model 116, etc.) via a cloud service provided by another entity and computing system.

The network interface 114 includes one or more hardware and/or software components that are generally configured to enable the computing system 102 to communicate, via the network 108, with other components and/or devices of the computing environment 100, such as the computing device 104 and the data store 106. To this end, the network interface 114 includes hardware and/or software that operates in accordance with at least one communication protocol of the network 108.

The network 108 includes one or more wired and/or wireless communication networks, such as a cellular network (e.g., 5G®, 4G LTE®, 3G®), a Wi-Fi® network (i.e., an IEEE 802.11 standards network), a microwave access network (e.g., WiMAX®), and/or any other suitable wide area network (WAN), local area network (LAN), personal area network (PAN), etc. As just one example, the network 108 may include both a wireless LAN such as a Wi-Fi® network and a WAN such as the Internet. In some embodiments, the network 108 includes multiple, entirely distinct/parallel networks (e.g., one or more networks for communications between computing system 102 and computing device 104, and one or more separate networks for communications between computing system 102 and data store 106, etc.).

The computing device 104 may be a desktop computer, a laptop computer, a tablet device, a mobile device, a wearable device (e.g., augmented or virtual reality glasses/headsets), or any other suitable computing device. The computing device 104 includes one or more processors 120, memory 122, one or more input/output (I/O) components 124, and a network interface 126.

The processor(s) 120 may include any suitable number of processors and/or processor types. In some examples, the processor(s) 120 include one or more CPUs, one or more GPUs, one or more TPUs, one or more FPGAs, one or more ASICs, and/or the like. Generally, the processor(s) 120 comprise hardware configured to execute instructions (e.g., processor-executable code/instructions) stored in the memory 122. The memory 122 may include any suitable memory type(s), including one or more volatile memories (e.g., dynamic and/or static RAM) and/or non-volatile memories (e.g., ROM, EPROM, EEROM, NAND flash, and/or SSD(s)), all or any of which are examples of non-transitory computer-readable media. In some examples, the memory 122 stores one or more of: an operating system; one or more software components (e.g., firmware, application(s), binary, source code, executable instructions, machine-learned model(s)); transient data and/or code loaded and/or operated on by one or more software component(s); and/or other suitable components/data). In the example computing environment 100, the memory 122 stores the processor-executable instructions of an application 127, which may be, for example, a web browser application or a dedicated application (e.g., a data visualization application offered/provided by an entity associated with computing system 102). Furthermore, the memory 122 may store testing data 128 that is used to detect degradation in post training performance of the machine-learned model 116 as described in more detail below.

The I/O component(s) 124 include hardware and/or software that generally enables a user of computing device 104 to interact with the computing device 104. The I/O component(s) 124 may include one or more input components that enable a user of computing device 104 to enter inputs to the computing device 104 (e.g., a keyboard, a microphone, etc.), one or more output components that enable the user to perceive outputs generated by the computing device 104 (e.g., a monitor/display, a speaker, a haptic feedback component, etc.), and/or one or more integrated I/O components (e.g., a touchscreen). The I/O component(s) 124 may use any suitable technology or technologies, such as LED, OLED, or LCD display technology, for example. While FIG. 1A shows computing device 104 as a single component communicating (via network 108) with the computing system 102, in some implementations the components of computing device 104 shown in FIG. 1A are instead divided among two or more client/user-side devices.

The network interface 126 includes one or more hardware and/or software components that are generally configured to enable the computing device 104 to communicate, via the network 108, with other components and/or devices of the computing environment 100, such as the computing device 104. To this end, the network interface 126 includes hardware and/or software that operates in accordance with at least one communication protocol of the network 108.

The data store 106 may be implemented as a database, data lake, memory, and/or other digital storage medium known in the art. Accordingly, the data store 106 may be a file system data store, an object-based data store, or other type of data store utilized in the art. Depending on the embodiment, the data store 106 may be implemented locally at the computing system 102, externally at an external data storage service, or a combination thereof. The computing system 102, via the network interface 114, may be in wired or wireless communication with the external data storage service. As described in more detail below, the data store 106 may store data that the computing system 102 uses to detect degradation in the post-training performance of the machine-learned model 116 with respect to the testing data 128. In particular, the data store 106 may store training data 130 that was used to train the current version of the machine-learned model 116.

The machine-learned model 116 and the causal inference machine-learned model 119 may comprise generative machine-learned model component(s), such as a transformer-based machine-learned model (e.g., a large-language model (LLM), an embedding model, a diffusion model, and/or the like), and may additionally or alternatively comprise other machine-learned model component(s), such as neural network(s), decision tree(s), and/or the like. In some examples, the machine-learned model 116 and the causal inference machine-learned model 119 are trained to use text as input and to generate text or, in other embodiments, may be a multimodal LLM that operates upon and/or generates text and also other types of content (e.g., text, images, audio, etc.). The machine-learned model 116 and the causal inference machine-learned model 119 may receive a text prompt (referred to herein at times as simply a “prompt”) as an input, process the text prompt, and output text content responsive to the text prompt. The machine-learned model 116 and the causal inference machine-learned model 119 may additionally or alternatively include a deep neural network and may perform various natural language processing tasks to understand a text query/prompt and generate a response to the text query/prompt, e.g., as part of a pre-processing operation and/or a post-processing operation. For example, in a pre-processing operation a neural network and/or another transformer-based machine-learned model may be trained to augment the original prompt to add sufficient context, which may be based on processing inputs determined from user and/or provider query responses, subsequent user and/or provider feedback, and/or the like, that is determined to be associated with the prompt. In a post-processing operation, the neural network and/or another transformer-based machine-learned model may be trained to review and alter, as necessary, an output of the transformer-based machine-learned model to be suitable for use by the machine-learned model 116 and the causal inference machine-learned model 119.

The machine-learned model 116 and the causal inference machine-learned model 119 may have a transformer-based model architecture that comprises an encoder that tokenizes the input and determines embeddings for the tokens, and a decoder that generates the output based at least in part on the embeddings. The transformer model may incorporate self-attention and/or cross-attention mechanisms to facilitate more accurate output. In some embodiments, such a transformer-based machine-learned model may include different configurations of self- and/or cross-attention, followed by neural network(s) (e.g., feedforward layer(s)), recurrent layer(s), aggregation layer(s) (e.g., using softmax, matrix multiplication, and/or other aggregation techniques), and/or the like. The machine-learned model 116 and the causal inference machine-learned model 119 may be a general-purpose model (e.g., trained on a wide array of publicly available datasets such as web pages, documents, etc., available via the Internet) such as a generative pre-trained transformer (GPT) 3.5, bi-directional encoder representations from transformers (BERT), or may be a domain-specific model (e.g., trained and/or fine-tuned on custom and/or proprietary datasets), such as a general purpose LLM trained using datasets of queries, responses, and user and/or provider feedback.

The functionality and operation of the machine-learned model 116, the one or more data processing components 118, and the causal inference machine-learned model 119 are described in further detail below in connection with FIG. 1B, according to some embodiments.

### Example Process for Detecting Machine-Learned Model Degradation

FIG. 1B depicts a first example operation of the computing system 102 and, in particular, a process 131 for detecting degradation of the machine-learned model 116 using the one or more data processing components 118, the causal inference machine-learned model 119, the testing data 128, and the training data 130. Furthermore, as shown in FIG. 1B, the one or more data processing components 118 may include a data matching component 118A and a performance detecting component 118B. For clarity, reference will also be made to the FIG. 1A and the components of the computing environment 100 throughout this section.

In general, before deployment, the machine-learned model 116 is trained and tested on a dataset that is representative of the whole population of foreseeable data. However, datasets collected periodically after deployment such as the testing data 128 may not be similarly representative. For example, the testing data 128 may be collected 1-2 months after production rather than a full year, which may introduce seasonal effects to the testing data 128 that are not indicative of degradation of the machine-learned model 116. To address this problem, the process 131 is configured to employ causal inference statistical methods when detecting performance of the machine-learned model 116. In general these methods designate the training data 130 as the control data and the testing data 128 as the treatment group and then detect performance of the machine-learned model 116 by monitoring for the equivalent of a “significant treatment effect” from the testing data 128 relative to the training data 130 (e.g., determining where differences between outputs of the machine-learned model 116 from the testing data 128 and the training data 130 are statistically significant enough to be attributable to changes in the testing data 128 rather than random chance).

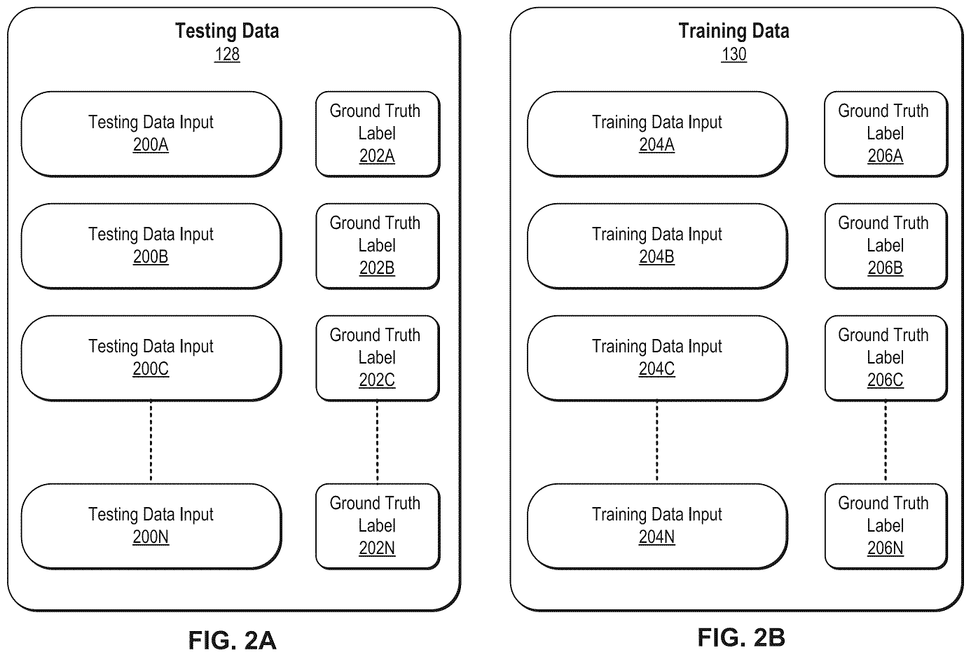

In operation, the computing system 102 may receive, via the network interface 114, the testing data 128 and the training data 130. The testing data 128 may be received from the computing device 104 or the data store 106. For example, in some embodiments, the computing device 104 may send the testing data 128 directly to the computing system 102 or may upload the testing data 128 to the data store 106. In the latter case, the computing system 102 may operate to detect performance of the machine-learned model 116 by periodically checking the data store 106 for the testing data 128 or by receiving a location indicator of the testing data 128 within the data store 106 from the computing device 104. The specific features of the testing data 128 and the training data 130 are discussed in more detail below in connection with FIGS. 2A and 2B.

After receiving the testing data 128 and the training data 130, the computing system 102 (e.g., the processor(s) 110 implementing the data matching component 118A) may determine a matched subset 132 of the training data 130. As described in more detail below, the matched subset 132 is the likely subset of the training data 130 whose feature distribution (X) is similar to the testing data 128. In this way the process 131 may make like-to-like performance comparisons and control for biases in the testing data 128.

The process 131 further includes the computing system 102 subsequently sampling the testing data 128 and the matched subset 132 to select testing data samples 134 and training data samples 136. The testing data samples 134 and training data samples 136 are then input through the machine-learned model 116 to generate test outputs 138 and training outputs 140. In some embodiments, the computing system 102 may pre-generate the training outputs 140 and store the pre-generated training outputs 140 in the data store 106 for recall when detecting performance of the machine-learned model 116 according to the process 131. However, in other embodiments a computing system different from the computing system 102 (e.g., another computing system executing the machine-learned model 116) may pre-generate the training outputs 140. In any case, the process 131 then includes the performance detecting component 118B processing one or more of the testing data 128, the training data 130, the matched subset 132, the test outputs 138, and the training outputs 140 to determine whether the machine-learned model 116 should be retrained or fine-tunned and to aggregate a retraining dataset 142 for any such retraining or fine-tuning. Furthermore, in some embodiments, the process 131 may alternatively include using the causal inference machine-learned model 119 to aggregate the retraining dataset 142 as described in more detail below.

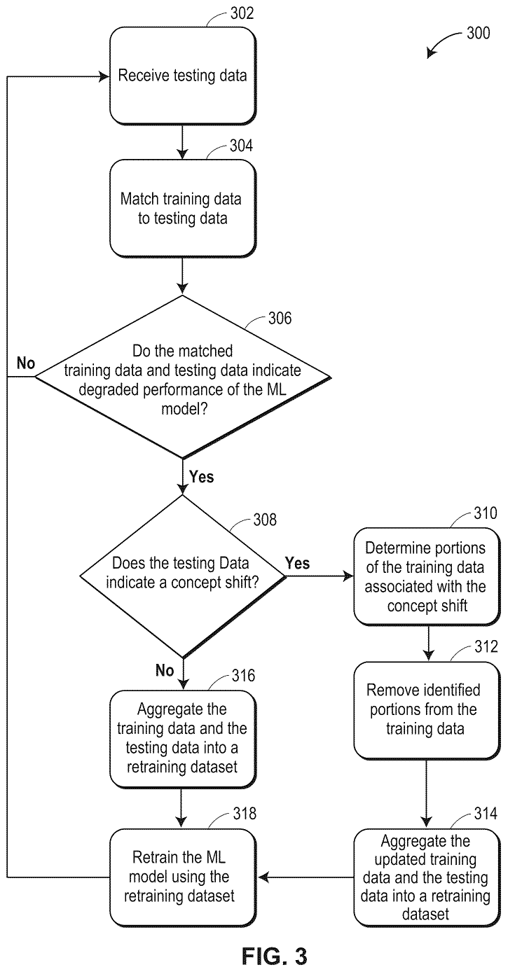

Operation of the computing system 102 to perform the process 131 is discussed in further detail below with respect to the method flow diagrams of FIGS. 3-7.

FIG. 2A shows a schematic diagram of the testing data 128. In general, the testing data 128 may include formatted or unformatted text, numbers, vectors, image data, multi modal data, etc. that are stored in a table, spreadsheet, csv, array, file, etc. Furthermore, the testing data 128 includes data gathered after the training or fine-tunning of the machine-learned model 116, which may be used in the process 131 to detect the current performance of the machine-learned model 116.

As shown in FIG. 2A, the testing data 128 includes a plurality of testing data inputs 200A, B, C, . . . N and associated ground truth labels 202A, B, C, . . . N. The testing data inputs 200A, B, C, . . . N may include one or more independent variables that predict or otherwise relate to the associated ground truth labels 202A, B, C, ...N. For example, the ground truth labels 202A, B, C, ...N may include a category, classification, or similar output that is dependent on the values and features of the testing data inputs 200A, B, C, . . . N. In some embodiments, testing data inputs 200A, B, C, . . . N include sequential data values or text and the ground truth labels 202A, B, C, . . . N include a next value, token, character, etc. in the sequence. In some embodiments, the computing system 102 or other computing system may select or designate the ground truth labels 202A, B, C, . . . N from the testing data inputs 200A, B, C, . . . N using masking techniques known in the art.

FIG. 2B depicts a schematic diagram of example training data 130. The training data 130 takes a form similar to that on the testing data 128 and includes a plurality of training data inputs 204A, B, C, . . . N and associated ground truth labels 206A, B, C, . . . N. The training data 130 includes the data used to train and fine-tune the current deployed instance of the machine-learned model 116. In particular, the training data 130 includes the data used to train the machine-learned model 116 to generate outputs that are similar to the associated ground truth labels 206A, B, C, . . . N (e.g., a category, classification, or next predicted values of the input data) when fed inputs similar to the training data inputs 204A, B, C, . . . N.

The computing system 102 selects the testing data samples 134 and the training data samples 136 (see FIG. 1B) from the testing data inputs 200A, B, C, . . . N and the training data inputs 204A, B, C, . . . N, respectively. In particular, the testing data inputs 200A, B, C, . . . N and the training data inputs 204A, B, C, . . . N may include a preconfigured number N of the testing data inputs 200A, B, C, . . . N and the training data inputs 204A, B, C, . . . N that the computing system 102 selects using a sampling-with-replacement or similar technique.

FIG. 3 depicts a flow diagram of an example computer-implemented method 300 for detecting degradation of the machine-learned model 116 using the process 131 as shown in FIG. 1B. The computer-implemented method 300 may be implemented by processor-executable instructions stored in the memory 112 when executed by processor(s) 110, for example.

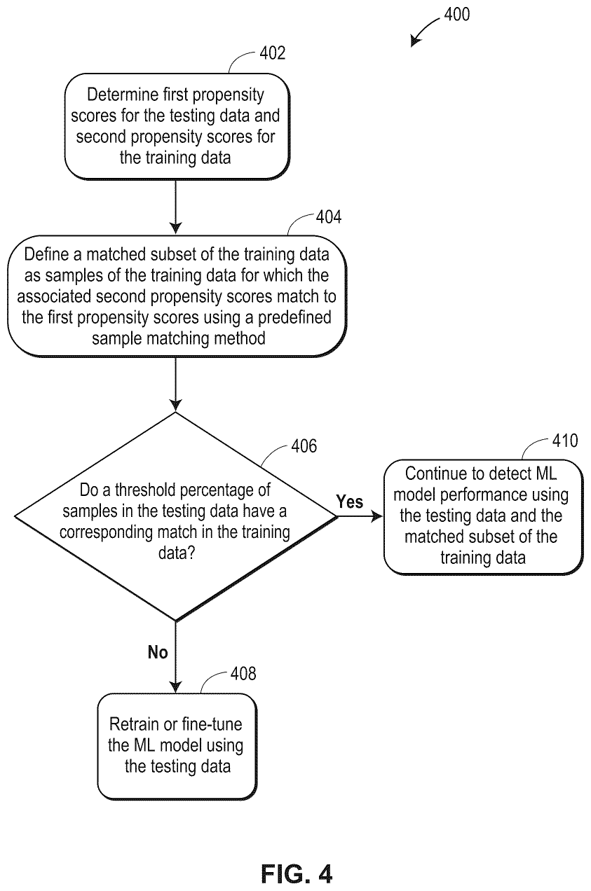

At operation 302, the computer-implemented method 300 includes receiving the testing data 128 at the computing system 102. For example, the computing system 102 may receive the testing data 128 from the computing device 104 or retrieve the testing data 128 from the data store 106. Then, at operation 304, the computer-implemented method 300 includes matching the testing data 128 to the training data 130. In particular, the computer-implemented method 300 includes the computing system 102 executing the data matching component 118A to determine the matched subset 132. The computer-implemented method 400, shown in FIG. 4, provides additional details for determining the matched subset 132 are described below in connection with.

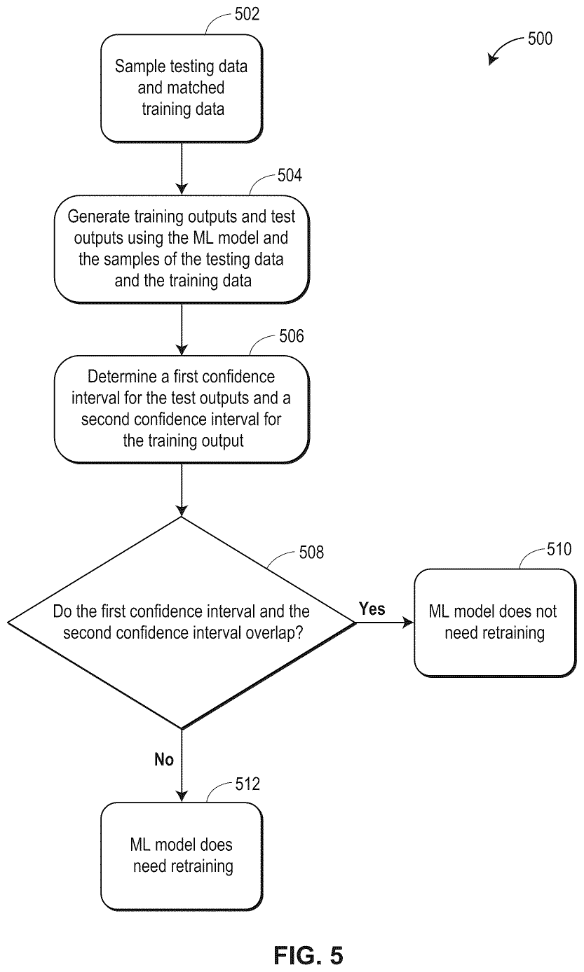

At operation 306, after the matched subset 132 is determined, the computer-implemented method 300 includes determining whether the matched subset 132 and the testing data 128 indicate degraded performance of machine-learned model 116. In general, the operation 306 may include generating the test outputs 138 and the training outputs 140 from the testing data samples 134 and the training data samples 136 and determining, by the performance detecting component 118B, one or more metrics to detect performance of the machine-learned model 116. The one or more metrics are based at least in part on the test outputs 138 and the training outputs 140. The computer-implemented method 500, shown in FIG. 5, provides additional details for detecting degraded performance of the machine-learned model 116.

When the computing system 102 (e.g., the performance detecting component 118B) determines that the machine-learned model 116 is not sufficiently (e.g., as described in more detail in connection with the computer implemented method 500 shown in of FIG. 5) degraded (e.g., in response to this determination), the computer-implemented method 300 may include waiting for receipt of additional new testing data at operation 302. Furthermore, in some embodiments, the computer-implemented method 300 may include combining any new testing data with the testing data 128 when detecting performance of the machine-learned model 116 in the future with respect to the new testing data. Alternatively, the method 300 may detect performance of the machine-learned model 116 in the future only with respect to the new testing data without considering the testing data 128.

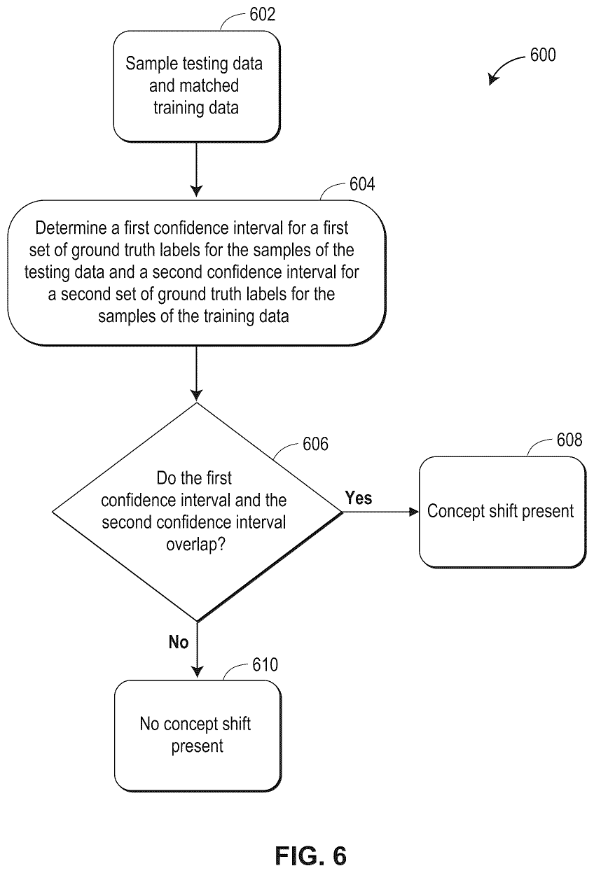

At operation 308, when the computing system 102 (e.g., the performance detecting component 118B) determines that the machine-learned model 116 is sufficiently degraded (e.g., in response to this determination), the computer-implemented method 300 may include determining whether the testing data 128 indicates the presence of a concept shift relative to the training data 130. A “concept shift,” as used herein, refers to cases where features of the testing data 128 represent new or conflicting patterns relative to patterns present in the training data 130. For example, the features or composition of the testing data inputs 200A, B, C, . . . N may have changed relative to the training data inputs 204A, B, C, . . . N such that associations between the features of the training data inputs 204A, B, C, . . . N and the associated ground truth labels 206A, B, C, . . . N trained or tuned into the machine-learned model 116 are no longer valid. Example features changes to the testing data inputs 200A, B, C, . . . N may include cases where different values or combinations of the testing data inputs 200A, B, C, . . . N are correlated with ground truth labels 202A, B, C, . . . N as compared with the training data inputs 204A, B, C, . . . N. An example composition change may include situations where the testing data inputs 200A, B, C, . . . N include new values or variables that correlate with the ground truth labels 202A, B, C, . . . N but that are generally not present in the training data inputs 204A, B, C, . . . N. Additionally or alternatively, the composition changes may include situations where the testing data inputs 200A, B, C, . . . N omit or otherwise remove one or more types of values generally present in the training data inputs 204A, B, C, . . . N. Additional details on determining whether the concept shift is present are described below in connection with the computer implemented method 600 shown in FIG. 6.

Additionally, a concept shift may be generalized as cases where any association between a label Y (e.g., the ground truth labels 202A, B, C, . . . N) and features X (e.g., the testing data inputs 200A, B, C, . . . N) changes over time in the testing data 128 relative to the training data 130. This data shift may relate to distribution change of features X and labels Y, which can be expressed as p(x, y)=p(y|x) p(x), where p(y|x) denotes the association between features X and labels Y, and changes of p(y|x) in new data is concept shift and changes in feature distribution p(x) are covariate shifts that do not require an update to the machine-learned model 116 (because the associations between X and Y still hold in the machine-learned model 116).

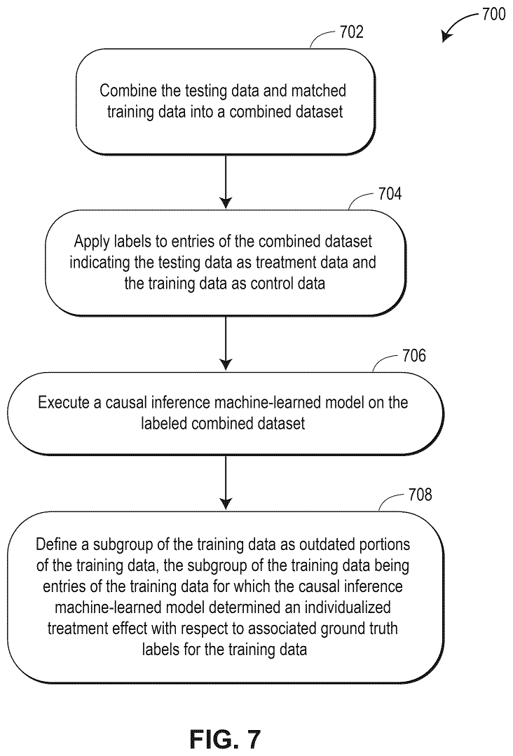

At operation 310, when the computing system 102 (e.g., the performance detecting component 118B) determines that the concept shift is present, the computer-implemented method 300 may include determining portions of the training data 130 and/or the matched subset 132 that is associated with the concept shift; and, at operation 312 removing those determined portions from the training data 130. In some embodiments, the computing system 102 may determine the portions of the training data 130 associated with the concept shift using the causal inference machine-learned model 119. In particular, the causal inference machine-learned model 119 may include a machine learned model trained to identify which (if any) of the individual entries or inputs of the testing data 128 and the training data 130 (e.g., the testing data inputs 200A-N and the training data inputs 204A-N) have a statistically significant individualized treatment effect (ITE) in cases where the testing data 128 operates as the treatment group and the training data 130 operates as the control group. Additional details of the operation of the causal inference machine-learned model 119 are described below in connection with computer-implemented method 700 shown in FIG. 7.

Then, after removing the determined portions, at operation 314, the computer-implemented method 300 may include aggregating the updated training data 130 (e.g., the training data 130 with the determined portions removed) and the testing data 128 into the retraining dataset 142. In this case the computing system 102 modifies the training data 130 because the computing system 102 detected the concept shift, and removes outdated material from the training data 130 associated with the concept shift so that retraining or fine-tuning of the machine-learned model 116 does not result in the machine-learned model 116 relearning patterns or correlations associated with the outdated concept.

Alternatively, at operation 316, when the computing system 102 (e.g., the performance detecting component 118B) determines that the concept shift is not present, the computer-implemented method 300 may include aggregating the training data 130 and the testing data 128 into a retraining dataset 142. In this case the training data 130 is not modified because the computing system 102 did not detect a concept shift and, thus, retraining or fine-tuning of the machine-learned model 116 to correct for the determined degradation can be accomplished without needing to remove any outdated material from the training data 130.

Then after operation 314 or 316, at operation 318, the computer-implemented method 300 may include retraining or fine-tuning the machine-learned model 116 using the retraining dataset 142 as constructed at operations 314 or 316. Retraining or fine-tuning the machine-learned model 116 may include executing the model with data input potions of the retraining dataset 142 (e.g., a combination of the testing data inputs 200A, B, C, . . . N and the training data inputs 204A, B, C, . . . N) to generate retraining outputs. The retraining outputs are then compared to the ground truth labels 202A, B, C, . . . N or 206A, B, C, . . . N as appropriate to calculate an error which is used to adjust the parameters of the machine-learned model 116 through backpropagation. In some embodiments, this process is repeated until the error is minimized (e.g., the error falls below a threshold, there is minimal change in the error between training runs, a preconfigured number of retraining runs have be executed, etc.) and the machine-learned model 116 is ready for redeployment.

In some embodiments, the computing system 102 may assign a higher weight or otherwise increase the prominence of the testing data 128 values in the retraining dataset 142 while retraining or fine-tuning the machine-learned model 116 at operation 318. Increasing the weight or prominence of the new data contained in the testing data 128 may allow the machine-learned model 116 to learn the new concepts or patterns embodied therein with fewer retraining or fine-tuning cycles.

After retraining at operation 318, the computer-implemented method 300 may include waiting for receipt of additional new testing data at operation 302 as described above after operation 306 except that the training data 130 as stored in the data store 106 is updated to reflect the retraining dataset 142. By returning to operation 302, the computer-implemented method 300 may form an iterative pipeline where new data is collected at continuous or regular intervals (e.g., batches indexed by time and collected monthly, semi-monthly, etc.) after deployment of any iteration of the machine-learned model 116, then the performance of the model is detected, and the model is updated as needed using the process 131 and one or more of the various computer-implemented methods described herein.

With reference now to FIG. 4, a flow diagram of an example computer-implemented method 400 for matching the testing data 128 and the training data 130 (e.g., a method to perform operation 304 of the method 300 and determine the matched subset 132) is shown. The computer-implemented method 400 may be implemented by processor-executable instructions stored in the memory 112 when executed by processor(s) 110, for example. In general, the computing system 102 (e.g., the data matching component 118A) determines the matched subset 132 using the causal inference statistical methods, where the training data 130 is treated as the control data and the testing data 128 is treated as the treatment group.

At operation 402, the computer implemented method 400 includes determining first propensity scores for the testing data 128 and second propensity scores for the training data 130. A propensity score is statistical tool calculated to balance the distribution of observed covariates in groups receiving the treatment versus those not receiving it. In the present case, the observed covariates correspond to the features of the testing data inputs 200A, B, C...N of the testing data 128 (e.g., the designated treatment group) and the training data inputs 204A, B, C...N of the training data 130 (e.g., the designated control group). The first and second propensity scores are the probability of being in the treatment group given a set of features. To calculate the propensity scores, the computing system 102 (e.g., the data matching component 118A) may employ a logistic regression or other suitable model where assignment to the treatment group (yes or no) is the dependent variable, and the covariates are the independent variables. The model estimates the probability (ranging from 0 to 1) that each data input would be in the treatment group.

At operation 404, after determining the first and second propensity scores, the computer implemented method 400 may include defining the matched subset 132 as samples of the training data 130 for which the associated second propensity scores match to the first propensity scores using a predefined sample matching method. Various predefined sample matching methods are possible. For example, at least one of nearest neighbor matching, optimal full matching, caliper matching, radius matching, kernel matching, Mahalanobis metric matching, stratification matching, or difference-in-differences matching as known in the art may be used to determine the matched subset 132 using the first and second propensity scores. In some embodiments, where there is no match in the training data 130 for some samples in the testing data 128, those unmatched samples of the testing data 128 may be copied and used as the matched values within the matched subset 132. Other matching methods may include methods that generally estimate an average treatment effect on a treated group or that employ weighting methods that estimate an average treatment effect. In some embodiments, doubly robust estimation may be used to combine various operations described herein. For example, the matching process as described for the computer-implemented method 400 may be combined with the performance determining processes as described below in connection with the computer-implemented method 500. In particular, a weighting based method may be used to combine the matching and performance determining processes.

At operation 406, the computer implemented method 400 may determine whether a threshold percentage (e.g., 25%, 30%, etc.) of samples in the testing data 128 have a corresponding match in the matched subset 132 of the training data 130. The operation 406 may enable the computing system 102 to determine situations where the testing data 128 has so substantially changed from the training data 130 that retraining or fine tuning of the machine-learned model 116 is needed even without detecting performance using the performance detecting component 118B as described herein. In some embodiments, the threshold percentage may be specified by user input to the computing system 102 (e.g., input received from the computing device 104).

At operation 408, when the computing system 102 determines that there are not a threshold percentage of matching samples, the computer implemented method 400 includes moving to retrain or fine-tune the ML model 116 using the testing data 128 without needing to perform other operations of the process 131 and/or the computer-implemented method 300 as described herein. In some embodiments, the computing system 102 may combine the testing data 128 with some or all of the training data 130 when retraining or fine-tuning the machine-learned model 116 at operation 408. However, at operation 410, when the computing system 102 determines that there is a threshold percentage of matching samples (i.e., the percentage of matching samples meets or exceeds a threshold percentage), the computer implemented method 400 includes continuing to detect performance of the machine-learned model 116 using the testing data 128 and the matched subset 132 of the training data 130.

With reference now to FIG. 5, a flow diagram of an example computer-implemented method 500 for determining that the machine-learned model 116 needs retraining or fine-tuning is shown. The computer-implemented method 500 may be implemented by processor-executable instructions stored in the memory 112 when executed by processor(s) 110, for example. In general, the computing system 102, continues to use the causal inference statistical method to detect the performance of the machine-learned model 116.

At operation 502, the computer-implemented method 500 may include the computing system 102 sampling the testing data 128 and the matched subset 132 to determine the testing data samples 134 and the training data samples 136. Then, at operation 504, the computer-implemented method 500 may include generating or retrieving the test outputs 138 and the training outputs 140. In particular, the computer-implemented method 500 may include the computing system 102 generating the test outputs 138 and the training outputs 140 by executing the machine-learned model 116 using the testing data samples 134 and the training data samples 136 as inputs. As described herein, in some embodiments, the training outputs 140 may alternatively be obtained from the data store 106 or other similar storage device.

At operation 506, the computer-implemented method 500 may include the computing system 102 (e.g., the performance detecting component 118B) determining a first confidence interval for the test outputs 138 and a second confidence interval for the training outputs 140. In some embodiments, the computing system 102 (e.g., the performance detecting component 118B) may use a bootstrap confidence interval determination processes to determine the first confidence interval and the second confidence interval. Furthermore, its should be appreciated that the first confidence interval and the second confidence interval may be determined by the computing system 102 with respect to performance metrics determined with respect to all the test outputs 138 and the training outputs 140. For example, the computing system 102 may determine an accuracy, an F1 score, AUC-ROC, mean absolute error, etc. collectively for the all the test outputs 138 and the training outputs 140, respectively and the first confidence interval and the second confidence interval many include a range that the computing system 102 determines, with a set percentage confidence (e.g., 99, 95, 90, etc.), that a true value for the performance metric falls within.

At operation 508, the computer-implemented method 500 may include the computing system 102 (e.g., the performance detecting component 118B) determining whether the first and second confidence intervals overlap or not. When the confidence intervals overlap, the computer-implemented method 500 may, at operation 510, include the computing system 102 (e.g., the performance detecting component 118B) determining that the machine-learned model 116 has degraded sufficiently to need retraining or fine-tuning. However, when the confidence intervals do overlap, the computer-implemented method 500 may, at operation 512, include the computing system 102 (e.g., the performance detecting component 118B) determining that the machine-learned model 116 has not degraded sufficiently to need retraining or fine-tuning. For example where the 95% confidence interval for the testing data 128 is a range of 2-4 and the 95% confidence interval for the training data 130 is 5-7, the computing system 102 will determine that the two confidence intervals do not overlap.

It should be appreciated that other metrics and methods for detecting the degradation of the machine-learned model 116 based on the test outputs 138 and training outputs 140 are possible. For example, the computing system 102 (e.g., the performance detecting component 118B) may determine difference values between matched ones of the test outputs 138 and training outputs 140 and determine that the machine-learned model 116 needs retraining or fine tuning when individual difference values, the maximum difference value, the minimum difference value the average of all the difference values, etc. exceeds a predefined threshold value. In some embodiments, the predefined threshold value may be set via user input received from the computing device 104. Furthermore, the computing system 102 may use hypothesis testing method, such as t-tests, z-tests, p-tests, chi-square tests, ANOVA, etc. to detect degradation in the machine-learned model 116.

With reference now to FIG. 6, a flow diagram of an example computer-implemented method 600 for determining that a concept shift is present is shown. The computer-implemented method 600 may be implemented by processor-executable instructions stored in the memory 112 when executed by processor(s) 110, for example. In general, the computing system 102, continues to use the causal inference statistical method to determine the presence of any concept shift in the testing data 128 when executing the computer-implemented method 600. Furthermore, the computer-implemented method 600 may include operations similar to that of the computer-implemented method 500 used to detect the performance of the machine-learned model 116 except that the causal inference methods are applied with respect to the ground truth labels (e.g., the ground truth labels 202A, B, C, . . . N and 206A, B, C, . . . N) in the testing data 128 and the training data 130 rather than the outputs generated by the machine-learned model 116 (e.g., the test outputs 138 and the training outputs 140).

Using similar and consistent causal inference methods for the computer-implemented methods 500 and 600 enables the computing system 102 to reliably determine whether any degradation in the machine-learned model 116 as determined by the computer-implemented method 500 is attributable to the presence of concept shift or not. This is because the matching process described in connection with the computer implemented method 400 controls the feature distribution p(x) to be the same in the testing data 128 and the matched subset 132. As a result, a difference in the label Y indicates a change of association between Y and the features X.

At operation 602, the computer-implemented method 600 may include sampling the testing data 128 and the matched subset 132 again or reusing the testing data samples 134 and the training data samples 136 previously determined by the computing system 102. Then, at operation 604, the computer-implemented method 600 may include determining a first confidence interval for a set of the ground truth labels 202A, B, C, . . . N for the samples of the testing data 128 and a second confidence interval for a set of the ground truth labels 206A, B, C, . . . N for the samples of the training data 130. In some embodiments the computing system 102 may determine the confidence intervals for the sets of ground truth labels based on summary statistics of the ground truth labels 202A, B, C, . . . N and the set of the ground truth labels 206A, B, C, . . . N, respectively. The summary statistics may be that same statistics and the performance metrics discussed above for the test outputs 138 and training outputs 140.

At operation 606, the computer-implemented method 600 may include determining whether the first confidence interval and the second confidence interval determined in operation 604 overlap. When the confidence intervals overlap, the computer-implemented method 600 may, at operation 608, include the computing system 102 (e.g., the performance detecting component 118B) determining that a concept shift is present. However, when the confidence intervals do overlap, the computer-implemented method 600 may, at operation 610, include the computing system 102 (e.g., the performance detecting component 118B) determining that the concept shift is not present.

As discussed above in connection with the computer-implemented method 500, other metrics and methods may be used to compare the ground truth labels 202A, B, C, . . . N and 206A, B, C, . . . N and determine the presence or non-presence of the concept shift. Such metrics and methods may include comparing individual difference values, a maximum difference value, a minimum difference value, an average of all the difference values, etc. for the ground truth labels to another predefined threshold value. Furthermore, alternatives utilize a parametric/non-parametric statistical test designed to detect performance of the outcomes of interest such as two sample t-test and two sample proportion tests may be used for continuous and binary outcomes.

With reference now to FIG. 7, a flow diagram of an example computer-implemented method 700 for determining portions of the training data 130 (or the matched subset 132) associated with a concept shift using the causal inference machine-learned model 119 is shown. The computer-implemented method 700 may be implemented by processor-executable instructions stored in the memory 112 when executed by processor(s) 110, for example.

At operation, 702, the computer-implemented method 700 may include the computing system 102 (e.g., the performance detecting component 118B) combining the testing data 128 and the matched subset 132 (or all of the training data 130) into a single combined dataset. Then, at operation 704, the computer-implemented method 700 may include applying labels to each entry or sample in the combined dataset indicating entries taken from the testing data 128 as treatment data and entries taken from the training data 130 as control data. In some embodiments, applying the labels to the entries in the combined dataset may include providing a distinct indicator input to the causal inference machine-learned model 119. For example, an indicator input of “0” may be used for treatment data (e.g., the testing data 128) and an indicator input of “1” may be used for the control data (e.g., the training data 130).

At operation 706, the computer-implemented method 700 may include the computing system 102 (e.g., the performance detecting component 118B) executing the causal inference machine-learned model 119 on the labeled combined dataset to generate one or more outputs used to determine the portions of the matched subset 132 (or the totality of the training data 130) associated with the identified concept shift. In particular, the one or more outputs of the causal inference machine-learned model 119 may indicate a subgroup of the training data 130 for which the causal inference machine-learned model 119 determines an individualized treatment effect (ITE) with respect to the associated ground truth labels 206A, B, C, . . . N. In some embodiments, the causal inference machine-learned model 119 may determine or classify the entries in subgroup of the training data 130 as having the ITE when a confidence interval or probability value for the ITE, output by the causal inference machine-learned model 119, is within a threshold level of confidence (e.g., 99%, 95%, 90%, etc.). Then, at operation 708 the computer-implemented method 700 includes defining this subgroup of the training data 130 as the outdated portions of the training data.

In some embodiments, the causal inference machine-learned model 119 includes an uplift tree model. In these embodiments, the one or more outputs of the causal inference machine-learned model 119 may include a plurality of predicted leaf node indicators for each sample in the matched subset 132 (or the training data 130). Decision paths of the output leaf nodes in the uplift tree model are defined as “definitions” of the subgroups of the matched subset 132 (or the training data 130) associated with the concept shift. Then, the computing system 102 (e.g., the performance detecting component 118B) may remove all samples from the matched subset 132 (or the training data 130) where the predicted leaf node indicators indicate association with the concept shift.

It should be appreciated that other versions of the causal inference machine-learned model 119 besides the uplift tree model may be used. Alternative models may include, a T-learner model, which estimates ITE for each individual sample and then uses a decision tree to partition data based on estimated ITE. Additionally, models that determine samples whose 95% bootstrap confidence intervals for their ITE do not contain 0.

It is to be understood that the operations of the methods 300, 400, 500, 600, and/or 700 may be performed in any suitable order (and/or in parallel), and/or may include fewer, additional, or different operations, in various embodiments.

### Example Computer Implemented Method

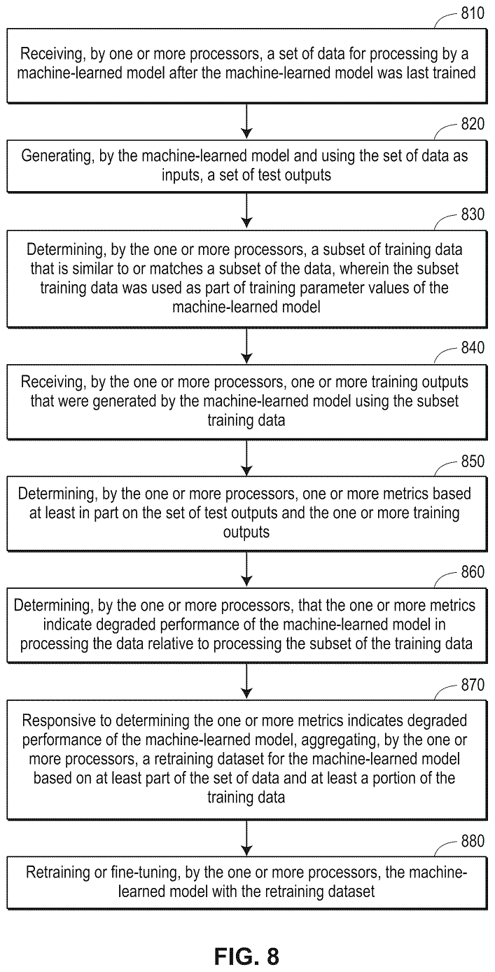

FIG. 8 is a flowchart of an example computer-implemented method 800 for detecting performance of an ML model (e.g., machine-learned model 116). The computer-implemented method 800 may be implemented by processor-executable instructions stored in the memory 112 when executed by processor(s) 110, for example.

At operation 810, the method 800 includes receiving, by one or more processors (e.g., processor(s) 110), a set of data for processing (e.g., testing data 128) by a machine-learned model (e.g., machine-learned model 116) after the machine-learned model was last trained.

At operation 820, the method 800 includes generating, by the machine-learned model and using the set of data as inputs, a set of test outputs (e.g., test outputs 138)

At operation 830, the method 800 includes determining, by the one or more processors, a subset (e.g., matched subset 132) of training data (e.g., training data 130) that is similar to or matches a subset of the data, wherein the subset training data was used as part of training parameter values of the machine-learned model.

At operation 840, the method 800 includes receiving, by the one or more processors, one or more training outputs (e.g., training outputs 140) that were generated by the machine-learned model using the subset training data.

At operation 850, the method 800 includes determining, by the one or more processors, one or more metrics based at least in part on the set of test outputs and the one or more training outputs.

At operation 860, the method 800 includes determining, by the one or more processors, that the one or more metrics indicate degraded performance of the machine-learned model in processing the data relative to processing the subset of the training data.

At operation 870, the method 800 includes, responsive to determining the one or more metrics indicates degraded performance of the machine-learned model, aggregating, by the one or more processors, a retraining dataset (e.g., retraining dataset 142) for the machine-learned model based on at least part of the set of data and at least a portion of the training data.

At operation 880, the method 800 includes retraining or fine-tuning, by the one or more processors, the machine-learned model with the retraining dataset.

### EXAMPLES

Example 1. A system comprising: one or more processors; and at least one memory storing processor-executable instructions that, when executed by the one or more processors, cause the one or more processors to perform operations comprising: receiving a set of data for processing by a machine-learned model after the machine-learned model was last trained; generating, by the machine-learned model and using the set of data as inputs, a set of test outputs; determining a subset of training data that is similar to or matches a subset of the data, wherein the subset training data was used as part of training parameter values of the machine-learned model; receiving one or more training outputs that were generated by the machine-learned model using the subset training data; determining one or more metrics based at least in part on the set of test outputs and the one or more training outputs; determining that the one or more metrics indicate degraded performance of the machine-learned model in processing the data relative to processing the subset of the training data; responsive to determining the one or more metrics indicates degraded performance of the machine-learned model, aggregating a retraining dataset for the machine-learned model based on at least part of the set of data and at least a portion of the training data; and retraining or fine-tuning the machine-learned model with the retraining dataset.

Example 2. The system of Example 1 wherein determining the subset of the training data that is similar to or matches the subset of the data includes: determining first propensity scores for samples in the set of data; determining second propensity scores for samples in the training data; and determining, as part of the subset of the data, one or more samples in the training data for which the associated second propensity scores match to the first propensity scores using a predefined sample matching method.

Example 3. The system of Examples 1 or 2 wherein predefined sample matching method includes at least one of nearest neighbor matching, optimal full matching, caliper matching, radius matching, kernel matching, Mahalanobis metric matching, stratification matching, or difference-in-differences matching.

Example 4. The system of any one of Examples 1-3 wherein determining the one or more metrics based at least in part on the set of test outputs and the one or more training outputs includes: determining a first confidence interval for the set of test outputs; and determining a second confidence for the one or more training outputs.

Example 5. The system of any one of Examples 1-4 wherein determining that the one or more metrics indicate degraded performance of the machine-learned model includes: determining that the first confidence interval and the second confidence interval fail to overlap.

Example 6. The system of any one of Examples 1-5 wherein aggregating the retraining dataset for the machine-learned model includes: determining that a concept shift is present in the set of data relative to the subset of the training data; determining outdated portions of the training data associated with the concept shift; and aggregating the retraining dataset to include the set of data and the training data absent the outdated portions.

Example 7. The system of any one of Examples 1-6 wherein determining that the concept shift is present in the set of data relative to the subset of the training data includes: determining a first confidence interval for a first set of ground truth labels for the set of data; determining a second confidence interval for a second set of ground truth labels for the subset of training data; and determining that the concept shift is present when first confidence interval and the second confidence interval fail to overlap.

Example 8. The system of any one of Examples 1-7 wherein determining the outdated portions of the training data associated with the concept shift includes: inputting the training data, the set of data. and ground truth labels associated with the training data and the set of data into a causal inference machine-learned model, where the training data is labeled as control data and the set of data is labeled as treatment data; receiving an output from the causal inference machine-learned model that identifies a subgroup of the training data for which the causal inference machine-learned model determined an individualized treatment effect with respect to the associated ground truth labels for the training data; and defining the subgroup of the training data as the outdated portions of the training data.

Example 9. The system of any one of Examples 1-8 wherein aggregating the retraining dataset for the machine-learned model includes: determining that a concept shift is not present in the set of data relative to the subset of the training data; and aggregating the retraining dataset to include the set of data and at least the subset of the training data.

Example 10. The system of any one of Examples 1-9 wherein aggregating the retraining dataset for the machine-learned model based on at least part of the set of data and at least a portion of the training data includes: assigning the set of data a greater weight in the retraining dataset as compared to the at least a portion of the training data.

Example 11. The system of any one of Examples 1-10 wherein the instructions, when executed by the one or more processors, cause the one or more processors to perform operations further comprising: retraining or fine-tuning the machine-learned model in response to determining that a threshold percentage of samples in the set of data fail to have a corresponding matched sample in the subset of training data.

Example 12. A computer-implemented method comprising: receiving, by one or more processors, a set of data for processing by a machine-learned model after the machine-learned model was last trained; generating, by the machine-learned model and using the set of data as inputs, a set of test outputs; determining, by the one or more processors, a subset of training data that is similar to or matches a subset of the data, wherein the subset training data was used as part of training parameter values of the machine-learned model; receiving, by the one or more processors, one or more training outputs that were generated by the machine-learned model using the subset training data; determining, by the one or more processors, one or more metrics based at least in part on the set of test outputs and the one or more training outputs; determining, by the one or more processors, that the one or more metrics indicate degraded performance of the machine-learned model in processing the data relative to processing the subset of the training data; responsive to determining the one or more metrics indicates degraded performance of the machine-learned model, aggregating, by the one or more processors, a retraining dataset for the machine-learned model based on at least part of the set of data and at least a portion of the training data; and retraining or fine-tuning, by the one or more processors, the machine-learned model with the retraining dataset.

Example 13. The method of Example 12 wherein determining the subset of the training data that is similar to or matches the subset of the data includes: determining first propensity scores for samples in the set of data; determining second propensity scores for samples in the training data; and determining, as part of the subset of the data, one or more samples in the training data for which the associated second propensity scores match to the first propensity scores using a predefined sample matching method.

Example 14. The method of Examples 12 or 13 wherein: determining the one or more metrics based at least in part on the set of test outputs and the one or more training outputs includes: determining a first confidence interval for the set of test outputs; and determining a second confidence for the one or more training outputs; and determining that the one or more metrics indicate degraded performance of the machine-learned model includes determining that the first confidence interval and the second confidence interval fail to overlap.

Example 15. The method of any one of Examples 12-14 wherein aggregating the retraining dataset for the machine-learned model includes: determining that a concept shift is present in the set of data relative to the subset of the training data; determining outdated portions of the training data associated with the concept shift; and aggregating the retraining dataset to include the set of data and the training data absent the outdated portions.

Example 16. The method of any one of Examples 12-15 wherein determining that the concept shift is present in the set of data relative to the subset of the training data includes: determining a first confidence interval for a first set of ground truth labels for the set of data; determining a second confidence interval for a second set of ground truth labels for the subset of training data; and determining that the concept shift is present when first confidence interval and the second confidence interval fail to overlap.

Example 17. The method of any one of Examples 12-16 wherein determining the outdated portions of the training data associated with the concept shift includes: inputting the training data, the set of data. and ground truth labels associated with the training data and the set of data into a causal inference machine-learned model, where the training data is labeled as control data and the set of data is labeled as treatment data; receiving an output from the causal inference machine-learned model that identifies a subgroup of the training data for which the causal inference machine-learned model determined an individualized treatment effect with respect to the associated ground truth labels for the training data; and defining the subgroup of the training data as the outdated portions of the training data.

Example 18. One or more non-transitory computer-readable media storing processor-executable instructions that, when executed by one or more processors, cause the one or more processors to perform operations comprising: receiving a set of data for processing by a machine-learned model after the machine-learned model was last trained; generating, by the machine-learned model and using the set of data as inputs, a set of test outputs; determining a subset of training data that is similar to or matches a subset of the data, wherein the subset training data was used as part of training parameter values of the machine-learned model; receiving one or more training outputs that were generated by the machine-learned model using the subset training data; determining one or more metrics based at least in part on the set of test outputs and the one or more training outputs; determining that the one or more metrics indicate degraded performance of the machine-learned model in processing the data relative to processing the subset of the training data; responsive to determining the one or more metrics indicates degraded performance of the machine-learned model, aggregating a retraining dataset for the machine-learned model based on at least part of the set of data and at least a portion of the training data; and retraining or fine-tuning the machine-learned model with the retraining dataset.

Example 19. The one or more non-transitory computer-readable media of Example 18 wherein determining the subset of the training data that is similar to or matches the subset of the data includes: determining first propensity scores for samples in the set of data; determining second propensity scores for samples in the training data; and determining, as part of the subset of the data, one or more samples in the training data for which the associated second propensity scores match to the first propensity scores using a predefined sample matching method.

Example 20. The one or more non-transitory computer-readable media of Examples 18 or 19 wherein aggregating the retraining dataset for the machine-learned model includes: determining that a concept shift is present in the set of data relative to the subset of the training data; determining outdated portions of the training data associated with the concept shift; and aggregating the retraining dataset to include the set of data and the training data absent the outdated portions.

### Additional Considerations

Throughout this specification, components, operations, or structures described as a single instance may be implemented as multiple instances. Although individual operations of one or more methods (or processes, techniques, routines, etc.) are illustrated and described as separate operations, two or more of the individual operations may be performed concurrently or otherwise in parallel, and nothing requires that the operations be performed in the order illustrated. Structures and functionality (e.g., operations, steps, blocks) presented as separate components in example configurations may be implemented as a combined structure, functionality, or component. Similarly, structures and functionality presented as a single component may be implemented as separate components. These and other variations, modifications, additions, and improvements fall within the scope of the subject matter herein.

Certain embodiments are described herein as including logic or a number of routines, subroutines, applications, operations, blocks, or instructions. These may constitute and/or be implemented by software (e.g., code embodied on a non-transitory, machine-readable medium), hardware, or a combination thereof. In hardware, the routines, etc., may represent tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware component that operates to perform certain operations as described herein.

In various embodiments, a hardware component may be implemented mechanically or electronically. For example, a hardware component may comprise dedicated circuitry or logic that is permanently configured (e.g., as a special-purpose processor, such as a field programmable gate array (FPGA) or an application-specific integrated circuit (ASIC)) to perform certain operations. A hardware component may also or instead comprise programmable logic or circuitry (e.g., as encompassed within one or more general-purpose processors and/or other programmable processor(s)) that is temporarily configured by software to perform certain operations.

Accordingly, the term “hardware component” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware components are temporarily configured (e.g., programmed), each of the hardware components need not be configured or instantiated at any one instance in time. For example, where the hardware components include a general-purpose processor configured using software, the general-purpose processor may be configured as respective different hardware components at different times. Software may accordingly configure a processor, for example, to constitute a particular hardware component at one instance of time and to constitute a different hardware component at a different instance of time.

Hardware components can provide information to, and receive information from, other hardware components. Accordingly, the described hardware components may be regarded as being communicatively coupled. Where multiple of such hardware components exist contemporaneously, communications may be achieved through signal transmission (e.g., over appropriate circuits and buses) that connect the hardware components. In embodiments in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information).

As noted above, the various operations of example methods (or processes, techniques, routines, etc.) described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions. The components referred to herein may, in some example embodiments, comprise processor-implemented components.

Moreover, each operation of processes illustrated as logical flow graphs may represent a sequence of operations that can be implemented in hardware, software, or a combination thereof. In the context of software, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

The terms “coupled” and “connected,” along with their derivatives, may be used. In particular embodiments, “connected” may be used to indicate that two or more elements are in direct physical or electrical contact with each other, although the context in the description may dictate otherwise when it is apparent that two or more elements are not in direct physical or electrical contact. “Coupled” may mean that two or more elements are in direct physical or electrical contact. However, “coupled” may also mean that two or more elements are not in direct contact with each other, yet still co-operate, transmit between, or interact with each other.

An algorithm may be considered to be a self-consistent sequence of acts or operations leading to a desired result. These include physical manipulations of physical quantities. Usually, though not necessarily, these quantities take the form of electrical, magnetic, or optical signals capable of being stored, transferred, combined, compared, and otherwise manipulated. These signals are commonly referred to as bits, values, elements, symbols, characters, terms, numbers, flags, or the like. It should be understood, however, that all of these and similar terms are to be associated with the appropriate physical quantities and are merely convenient labels applied to these quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “some embodiments,” “one embodiment,” “an embodiment,” “in some examples,” or variations thereof means that a particular element, feature, structure, characteristic, operation, or the like described in connection with the embodiment is included in at least one embodiment, but not every embodiment necessarily includes the particular element, feature, structure, characteristic, operation, or the like. Different instances of such a reference in various places in the specification do not necessarily all refer to the same embodiment, although they may in some cases. Moreover, different instances of such a reference may describe elements, features, structures, characteristics, operations, or the like be combined in any manner as an embodiment.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless the context of use clearly indicates otherwise, “or” refers to an inclusive or and not to an exclusive or. For example, a condition A or B is satisfied by any one of the following: A is true (or present) and B is false (or not present), A is false (or not present) and B is true (or present), and both A and B are true (or present).

The term “set” is intended to mean a collection of elements and can be a null set (i.e., a set containing zero elements) or may comprise one, two, or more elements. A “subset” is intended to mean a collection of elements that are all elements of a set, but that does not include other elements of the set. A first subset of a set may comprise zero, one, or more elements that are also elements of a second subset of the set. The first subset may be said to be a subset of the second subset if all the elements of the first subset are elements of the second subset, while also being a subset of the set. However, if all the elements of the second subset are also elements of the first subset (in addition to all the elements of the first subset being elements of the second subset), the first subset and the second subset are a single subset/not distinct.

For the purposes of the present disclosure, the term “a” or “an” entity refers to one or more of that entity. As such, the terms “a” or “an”, “one or more”, and “at least one” can be used interchangeably herein unless explicitly contradicted by the specification using the word “only one” or similar. For example, “a first element” may functionally be interpreted as “a first one or more elements” or a “first at least one element.” Unless otherwise apparent from the context of use, reference in the present disclosure to a same set of “one or more processors” (or a same “plurality of processors,” etc.) performing multiple operations can encompass implementations in which performance of the operations is divided among the processor(s) in any suitable way. For example, “generating, by one or more processors, X; and generating, by the one or more processors, Y” can encompass: (1) implementations in which a first subset of the processors (e.g., in a first computing device) generates X and an entirely distinct, second subset of the processors (e.g., in a different, second computing device) independently generates Y; (2) implementations in which one or more or all of the processor(s) (e.g., one or multiple processors in the same device, or multiple processors distributed among multiple devices) contribute to the generation of X and/or Y; and (3) other variations. This may similarly be applied to any other component or feature similarly recited (e.g., as “a component”, “a feature”, “one or more components”, “one or more features”, “a plurality of components”, “a plurality of features”). Moreover, the performance of certain of the operations may be distributed among the one or more components, not only residing within a single machine, but deployed across a number of machines. The set of components may be located in a single geographic location (e.g., within a home environment, an office environment, a cloud environment). In other example embodiments, the set of components may be distributed across two or more geographic locations. Further, “a machine-learned model”, equivalent terms (e.g., “machine learning model,” “machine-learning model,” “machine-learned component”, “artificial intelligence”, “artificial intelligence component”), or species thereof (e.g., “a large language model”, “a neural network”) may include a single machine-learned model or multiple machine-learned models, such as a pipeline comprising two or more machine-learned models arranged in series and/or parallel, an agentic framework of machine-learned models, or the like.

An “artificial intelligence” or “artificial intelligence component” may comprise a machine-learned model. A machine-learned model may comprise a hardware and/or software architecture having structural hyperparameters defining the model's architecture and/or one or more parameters (e.g., coefficient(s), weight(s), biase(s), activation function(s) and/or action function type(s) in examples where the activation function and/or function type is determined as part of training, clustering centroid(s)/medoid(s), partition(s), number of trees, tree depth, split parameters) determined as a result of training the machine-learned model based at least in part on training hyperparameters (e.g., for supervised, semi-supervised, and reinforcement learning models) and/or by iteratively operating the machine-learned model according to the training hyperparameters(e.g., for unsupervised machine-learned models).

In some examples, structural hyperparameter(s) may define component(s) of the model's architecture and/or their configuration/order, such as, for example, the configuration/order specifying which input(s) are provided to one component and which output(s) of that component are provided as input to other component(s) of the machine-learned model; a number, type, and/or configuration of component(s) per layer; a number of layers of the model; a number and/or type of input nodes in an input layer of the model; a number and/or type of nodes in a layer; a number and/or type of output nodes of an output layer of the model; component dimension (e.g., input size versus output size); a number of trees; a maximum tree depth; node split parameters; minimum number of samples in a leaf node of a tree; and/or the like. The component(s) of the model may comprise one or more activation functions and/or activation function type(s) (e.g., gated linear unit (GLU), such as a rectified linear unit (ReLU), leaky RELU, Gaussian error linear unit (GELU), Swish, hyperbolic tangent), one or more attention mechanism and/or attention mechanism types (e.g., self-attention, cross-attention), nodes and split indications and/or probabilities in a decision tree, and/or various other component(s) (e.g., adding and/or normalization layer, pooling layer, filter). Various combinations of any these components (as defined by the structural hyperparameter(s)) may result in different types of model architectures, such as a transformer-based machine-learned model (e.g., encoder-only model(s), encoder-decoder model(s), decoder-only models, generative pre-trained transformer(s) (GPT(s))), neural network(s), multi-layer perceptron(s), Kolmogorov-Arnold network(s), clustering algorithm(s), support vector machine(s), gradient boosting machine(s), and/or the like. The structural parameters and components a machine-learned model comprises may vary depending on the type of machine-learned model.

Training hyperparameter(s) may be used as part of training or otherwise determining the machine-learned model. In some examples, the training hyperparameter(s), in addition to the training data and/or input data, may affect determining the parameter(s) of the target machine-learned model. Using a different set of training hyperparameters to train two machine-learned models that have the same architecture (i.e., the same structural hyperparameters) and using the same training data may result in the parameters of the first machine-learned model differing from the parameters of the second machine-learned model. Despite having the same architecture and having been trained using the same training data, such machine-learned models may generate different outputs from each other, given the same input data. Accordingly, accuracy, precision, recall, and/or bias may vary between such machine-learned models.

In some examples, training hyperparameter(s) may include a train-test split ratio, activation function and/or activation function type (e.g., in examples like Kolmogorov-Arnold networks (KANs) where the activation function type is determined as part of training from an available set of activation functions and/or limits on the activation function parameters specified by the training hyperparameters), training stage(s) (e.g., using a first set of hyperparameters for a first epoch of training, a second set of hyperparameters for a second epoch of training), a batch size and/or number of batches of data in a training epoch, a number of epochs of training, the loss function used (e.g., L1, L2, Huber, Cauchy, cross entropy), the component(s) of the machine-learned model that are altered using the loss for a particular batch or during a particular epoch of training (e.g., some components may be “frozen,” meaning their parameters are not altered based on the loss), learning rate, learning rate optimization algorithm type (e.g., gradient descent, adaptive, stochastic) used to determine an alteration to one or more parameters of one or more components of the machine-learned model to reduce the loss determined by the loss function, learning rate scheduling, and/or the like.

In some examples, the structural hyperparameters and/or the training hyperparameters may be determined by a hyperparameter optimization algorithm or based on user input, such as a software component written by a user or generated by a machine-learned model. The machine-learned model may include any type of model configured, trained, and/or the like to generate a prediction output for a model input. In some examples, any of the logic, component(s), routines, and/or the like discussed herein may be implemented as a machine-learned model.

The machine-learned model may include one or more of any type of machine-learned model including one or more supervised, unsupervised, semi-supervised, and/or reinforcement learning models. Training a machine-learned model may comprise altering one or more parameters of the machine-learned model (e.g., using a loss optimization algorithm) to reduce a loss. Depending on whether the machine-learned model is supervised, semi-supervised, unsupervised, etc. this loss may be determined based at least in part on a difference between an output generated by the model and ground truth data (e.g., a label, an indication of an outcome that resulted from a system using the output), a cost function, a fit of the parameter(s) to a set of data, a fit of an output to a set of data, and/or the like. In some examples, determining an output by a machine-learned model may comprise executing a set of inference operations executed by the machine-learned model according to the target machine-learned model's parameter(s) and structural hyperparameter(s) and using/operating on a set of input data.

Moreover, any discussion of receiving data associated with an individual that may be protected, confidential, or otherwise sensitive information, is understood to have been preceded by transmitting a notice of use of the data to a computing device, account, or other identifier (collectively, “identifier”) associated with the individual, receiving an indication of authorization to use the data from the identifier, and/or providing a mechanism by which a user may cause use of the data to cease or a copy of the data to be provided to the user.

Upon reading this disclosure, those of skill in the art will appreciate still additional alternative structural and functional designs through the principles disclosed herein. Therefore, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

The patent claims at the end of this patent application are not intended to be construed under 35 U.S.C. § 112(f) unless traditional means-plus-function language is expressly recited, such as “means for” or “step for” language being explicitly recited in the claim(s).

What is claimed is:

1. A system comprising:
one or more processors; and
at least one memory storing processor-executable instructions that, when executed by the one or more processors, cause the one or more processors to perform operations comprising:
receiving a set of data for processing by a machine-learned model after the machine-learned model was last trained;
generating, by the machine-learned model and using the set of data as inputs, a set of test outputs;
determining a subset of training data that is similar to or matches a subset of the data, wherein the subset training data was used as part of training parameter values of the machine-learned model;
receiving one or more training outputs that were generated by the machine-learned model using the subset training data;
determining one or more metrics based at least in part on the set of test outputs and the one or more training outputs;
determining that the one or more metrics indicate degraded performance of the machine-learned model in processing the data relative to processing the subset of the training data;
responsive to determining the one or more metrics indicates degraded performance of the machine-learned model, aggregating a retraining dataset for the machine-learned model based on at least part of the set of data and at least a portion of the training data; and
retraining or fine-tuning the machine-learned model with the retraining dataset.

2. The system of claim 1 wherein determining the subset of the training data that is similar to or matches the subset of the data includes:
determining first propensity scores for samples in the set of data;
determining second propensity scores for samples in the training data; and
determining, as part of the subset of the data, one or more samples in the training data for which the associated second propensity scores match to the first propensity scores using a predefined sample matching method.

3. The system of claim 2 wherein predefined sample matching method includes at least one of nearest neighbor matching, optimal full matching, caliper matching, radius matching, kernel matching, Mahalanobis metric matching, stratification matching, or difference-in-differences matching.

4. The system of claim 1 wherein determining the one or more metrics based at least in part on the set of test outputs and the one or more training outputs includes:
determining a first confidence interval for the set of test outputs; and
determining a second confidence for the one or more training outputs.

5. The system of claim 4 wherein determining that the one or more metrics indicate degraded performance of the machine-learned model includes:
determining that the first confidence interval and the second confidence interval fail to overlap.

6. The system of claim 1 wherein aggregating the retraining dataset for the machine-learned model includes:
determining that a concept shift is present in the set of data relative to the subset of the training data;
determining outdated portions of the training data associated with the concept shift; and
aggregating the retraining dataset to include the set of data and the training data absent the outdated portions.

7. The system of claim 6 wherein determining that the concept shift is present in the set of data relative to the subset of the training data includes:
determining a first confidence interval for a first set of ground truth labels for the set of data;
determining a second confidence interval for a second set of ground truth labels for the subset of training data; and
determining that the concept shift is present when first confidence interval and the second confidence interval fail to overlap.

8. The system of claim 6 wherein determining the outdated portions of the training data associated with the concept shift includes:
inputting the training data, the set of data. and ground truth labels associated with the training data and the set of data into a causal inference machine-learned model, where the training data is labeled as control data and the set of data is labeled as treatment data;
receiving an output from the causal inference machine-learned model that identifies a subgroup of the training data for which the causal inference machine-learned model determined an individualized treatment effect with respect to the associated ground truth labels for the training data; and
defining the subgroup of the training data as the outdated portions of the training data.

9. The system of claim 1 wherein aggregating the retraining dataset for the machine-learned model includes:
determining that a concept shift is not present in the set of data relative to the subset of the training data; and
aggregating the retraining dataset to include the set of data and at least the subset of the training data.

10. The system of claim 1 wherein aggregating the retraining dataset for the machine-learned model based on at least part of the set of data and at least a portion of the training data includes:
assigning the set of data a greater weight in the retraining dataset as compared to the at least a portion of the training data.

11. The system of claim 1 wherein the instructions, when executed by the one or more processors, cause the one or more processors to perform operations further comprising:
retraining or fine-tuning the machine-learned model in response to determining that a threshold percentage of samples in the set of data fail to have a corresponding matched sample in the subset of training data.

12. A computer-implemented method comprising:
receiving, by one or more processors, a set of data for processing by a machine-learned model after the machine-learned model was last trained;
generating, by the machine-learned model and using the set of data as inputs, a set of test outputs;
determining, by the one or more processors, a subset of training data that is similar to or matches a subset of the data, wherein the subset training data was used as part of training parameter values of the machine-learned model;
receiving, by the one or more processors, one or more training outputs that were generated by the machine-learned model using the subset training data;
determining, by the one or more processors, one or more metrics based at least in part on the set of test outputs and the one or more training outputs;
determining, by the one or more processors, that the one or more metrics indicate degraded performance of the machine-learned model in processing the data relative to processing the subset of the training data;
responsive to determining the one or more metrics indicates degraded performance of the machine-learned model, aggregating, by the one or more processors, a retraining dataset for the machine-learned model based on at least part of the set of data and at least a portion of the training data; and
retraining or fine-tuning, by the one or more processors, the machine-learned model with the retraining dataset.

13. The method of claim 12 wherein determining the subset of the training data that is similar to or matches the subset of the data includes:
determining first propensity scores for samples in the set of data;
determining second propensity scores for samples in the training data; and
determining, as part of the subset of the data, one or more samples in the training data for which the associated second propensity scores match to the first propensity scores using a predefined sample matching method.

14. The method of claim 12 wherein:
determining the one or more metrics based at least in part on the set of test outputs and the one or more training outputs includes:
determining a first confidence interval for the set of test outputs; and
determining a second confidence for the one or more training outputs; and
determining that the one or more metrics indicate degraded performance of the machine-learned model includes determining that the first confidence interval and the second confidence interval fail to overlap.

15. The method of claim 12 wherein aggregating the retraining dataset for the machine-learned model includes:
determining that a concept shift is present in the set of data relative to the subset of the training data;
determining outdated portions of the training data associated with the concept shift; and
aggregating the retraining dataset to include the set of data and the training data absent the outdated portions.

16. The method of claim 15 wherein determining that the concept shift is present in the set of data relative to the subset of the training data includes:
determining a first confidence interval for a first set of ground truth labels for the set of data;
determining a second confidence interval for a second set of ground truth labels for the subset of training data; and
determining that the concept shift is present when first confidence interval and the second confidence interval fail to overlap.

17. The method of claim 15 wherein determining the outdated portions of the training data associated with the concept shift includes:
inputting the training data, the set of data. and ground truth labels associated with the training data and the set of data into a causal inference machine-learned model, where the training data is labeled as control data and the set of data is labeled as treatment data;
receiving an output from the causal inference machine-learned model that identifies a subgroup of the training data for which the causal inference machine-learned model determined an individualized treatment effect with respect to the associated ground truth labels for the training data; and
defining the subgroup of the training data as the outdated portions of the training data.

18. One or more non-transitory computer-readable media storing processor-executable instructions that, when executed by one or more processors, cause the one or more processors to perform operations comprising:
receiving a set of data for processing by a machine-learned model after the machine-learned model was last trained;
generating, by the machine-learned model and using the set of data as inputs, a set of test outputs;
determining a subset of training data that is similar to or matches a subset of the data, wherein the subset training data was used as part of training parameter values of the machine-learned model;
receiving one or more training outputs that were generated by the machine-learned model using the subset training data;
determining one or more metrics based at least in part on the set of test outputs and the one or more training outputs;
determining that the one or more metrics indicate degraded performance of the machine-learned model in processing the data relative to processing the subset of the training data;
responsive to determining the one or more metrics indicates degraded performance of the machine-learned model, aggregating a retraining dataset for the machine-learned model based on at least part of the set of data and at least a portion of the training data; and
retraining or fine-tuning the machine-learned model with the retraining dataset.

19. The one or more non-transitory computer-readable media of claim 18 wherein determining the subset of the training data that is similar to or matches the subset of the data includes:
determining first propensity scores for samples in the set of data;
determining second propensity scores for samples in the training data; and
determining, as part of the subset of the data, one or more samples in the training data for which the associated second propensity scores match to the first propensity scores using a predefined sample matching method.

20. The one or more non-transitory computer-readable media of claim 18 wherein aggregating the retraining dataset for the machine-learned model includes:
determining that a concept shift is present in the set of data relative to the subset of the training data;
determining outdated portions of the training data associated with the concept shift; and
aggregating the retraining dataset to include the set of data and the training data absent the outdated portions.
